(19) United States
(12) Patent Application Publication
(10) Pub. No.: US 2003/0002968 A1
(43) Pub. Date: Jan. 2, 2003

(54) Lift and load dolly

(76) Inventor: Kirk W. Nance, Helena, MT (US)

Correspondence Address: LAW OFFICE OF KAREN DANA OSTER, LLC, PMB 1020, 15450 SW BOONES FERRY ROAD #9, LAKE OSWEGO, OR, 97035, US

(21) Appl. No.: 10/017,049

(22) Filed: Dec. 13, 2001

Related U.S. Application Data
(60) Provisional application No. 60/301,578, filed on Jun. 27, 2001.

(51) Int. Cl. B60P 1/64

(52) U.S. Cl. 414/498

(57) ABSTRACT

A dolly for loading equipment on a dolly, transporting, and lifting or lowering equipment onto a receiving surface preferably includes a base frame and a slideable load bracket connected to the base frame. A power system may be used for extending and retracting the load bracket between an equipment-transfer mode, an equipment transport mode, and a weight-shift mode. The load bracket alone or the load bracket and the base frame are pivotable in relation to at least part of the front end of the base frame. Mobility-enabling devices and an operational member may also be connected to the base frame. The present invention also includes methods for lifting and lowering equipment using the dolly.

This application is based on and claims priority from provisional patent application serial No. 60/301,578, filed Jun. 27, 2001.

### BACKGROUND OF INVENTION

The present invention is directed to equipment dollies and particularly to dollies for transporting, lifting, and loading equipment onto raised or lowered receiving surfaces.

A forklift or crane is generally required to lift and load heavy equipment onto a “receiving surface,” such as a raised or lowered platform, loading dock, truck, train, flatbed trailer, any load-carrying vehicle, or any similar surface that could receive equipment. Lighter equipment, supplies, and walk-behind power tools, such as rototillers, concrete power trowels, and floor polishers (“equipment”), that do not require a crane or forklift may still be too heavy to be lifted onto a vehicle or raised platform by the average person. Walk-behind power tools typically have heavy components, such as internal combustion engines or electric motors connected to functional devices, such as blades. Concrete power trowels, for example, weigh 300-400 lbs. Even power tools that are lightweight enough to lift may be bulky and too cumbersome for one person to lift. For example, a lightweight lawn mower may require two or more people to lift and load it onto the bed of a pickup truck.

Besides being too heavy or bulky to lift, equipment may be difficult to move or transport across the ground or floor. Although many walk-behind power tools such as lawn mowers and snow blowers have wheels so that they can be pushed along the ground, other walk-behind power tools have wheels that are designed for stable transport over only short distances. The wheels do not engage the ground unless a human operator maintains downward pressure on a handle to shift the weight of the tool from a pad or blade to the wheels.

Furniture and appliance “hand dollies” provide one solution for moving equipment along surfaces, such as ground surfaces or stairs. Hand dollies alone, however, are unable to significantly raise and lower equipment onto a receiving surface. To move equipment with a furniture dolly to a receiving surface that is at a height significantly different from the ground surface requires a ramp or other suitable equipment. Although some trucks or perhaps loading docks may have built-in or permanent ramps, others do not. Makeshift ramps may be constructed from materials such as plywood, or no ramp at all is used.

U.S. Pat. No. 5,441,378 to Puls (the “Puls reference”) discloses a device that attaches to the front end of a snowmobile to assist in the movement or storage of the snowmobile. Although the Puls reference provides some lift provision, it cannot convey a snowmobile from one level to a significantly higher or lower receiving surface.

Other devices that attempt to address the problem of lifting and loading equipment onto a receiving surface tend to rely on standard vertical forklift technology that simply raises and lowers equipment using hydraulic, mechanical, or other means. These forklift devices can also permit the movement of equipment over surfaces, but they are heavy, expensive, and difficult to transport. Therefore, these forklift devices are rarely available at small jobsites.

### BRIEF SUMMARY OF THE INVENTION

The present invention is directed to a lift and load dolly suitable lifting (or lowering) and loading equipment from a starting surface to a receiving surface. More specifically, the dolly is suitable for loading equipment onto the dolly, supporting the equipment on the dolly, transporting equipment on the dolly, and lifting or lowering equipment (either together with the dolly or by itself) from a starting surface onto a receiving surface.

A dolly of the present invention preferably includes a base frame and a slideable load bracket connected to the base frame. A power system may be used for extending and retracting the load bracket between an equipment-transfer mode, an equipment transport mode, and a weight-shift mode. The load bracket alone or the load bracket and the base frame are pivotable in relation to at least part of the front end of the base frame. Mobility-enabling devices and an operational member may also be connected to the base frame.

The present invention also includes methods for lifting and lowering equipment using the dolly.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a side view of one preferred embodiment of a dolly of the present invention having a base frame and a load bracket in an exemplary equipment-transfer mode with the load bracket extended beyond the base frame.

FIGS. 2A and 2B are detailed views of an exemplary mobility-enabling device of FIG. 1 that is suitable for positioning the dolly in the exemplary equipment-transfer mode.

FIG. 3 is a perspective view of a second preferred embodiment of a dolly of the present invention in an equipment transport mode with the load bracket substantially coextensive with the base frame, this embodiment having an alternative operational member and alternative mobility-enabling devices.

FIG. 4 is a side view of an exemplary dolly having the exemplary mobility-enabling devices of FIG. 2 in a receiving surface contact position, with the mobility-enabling devices of the front end of the base frame being in contact with a lower starting surface and the mobility-enabling devices of the rear end of the base frame being in contact with a higher receiving surface.

FIG. 5 is a side view of an exemplary dolly in a weight-shift mode with the load bracket extended beyond the base frame, the dolly remaining in the receiving surface contact position, and a phantom depiction of the dolly after it has been pivoted in relation to the front end of the base frame.

FIG. 6 is a side view of an exemplary dolly after it has been moved onto the receiving surface and a phantom depiction of the dolly in the equipment-transfer mode.

FIG. 7 is a back view of a third preferred embodiment of a dolly of the present invention and equipment in the back of a truck, the mobility-enabling devices being pneumatic tires and the operational member being an “H-frame.”

FIG. 8 is a side view of a fourth preferred embodiment of a dolly of the present invention, having at least one foot near the front end in a receiving surface contact position with the foot of the dolly being in contact with the higher receiving surface and the mobility-enabling devices of the rear end of the base frame being in contact with the lower starting surface.

FIG. 9 is a side view of the dolly of FIG. 8 in a weight-shift mode with the load bracket extended beyond the base frame, the dolly remaining in the receiving surface contact position.

FIG. 10 is a side view of the dolly of FIG. 8 after it has been pivoted in relation to the front end of the base frame and a phantom optional support member.

FIG. 11 is a side view of a fifth preferred embodiment of a dolly of the present invention, having a pivotable load bracket after the load bracket has been pivoted in relation to the front end of the base frame.

FIG. 12 is a plan view of a first preferred embodiment of a power system, having a two-winch and two-cable system for extending and retracting the load bracket in relation to the base frame.

FIG. 13 is a perspective view of a second preferred embodiment of a power system having an electric motor and a worm screw for extending and retracting the load bracket in relation to the base frame.

FIG. 14 is a plan view of a third preferred embodiment of a power system having a single winch-and-cable system for extending and retracting the load bracket in relation to the base frame.

FIG. 15 is a side view of equipment supported in an equipment-maintenance position on an exemplary dolly of the present invention that has a maintenance securer on its operational member.

FIGS. 16A and 16B are a flowchart of an exemplary preferred method for loading equipment from a lower surface onto a higher surface using a dolly having a base frame and a load bracket.

FIG. 17 is a flowchart of an exemplary preferred method for unloading equipment from a higher surface onto a lower surface using a dolly having a base frame and a load bracket.

### DETAILED DESCRIPTION OF THE INVENTION

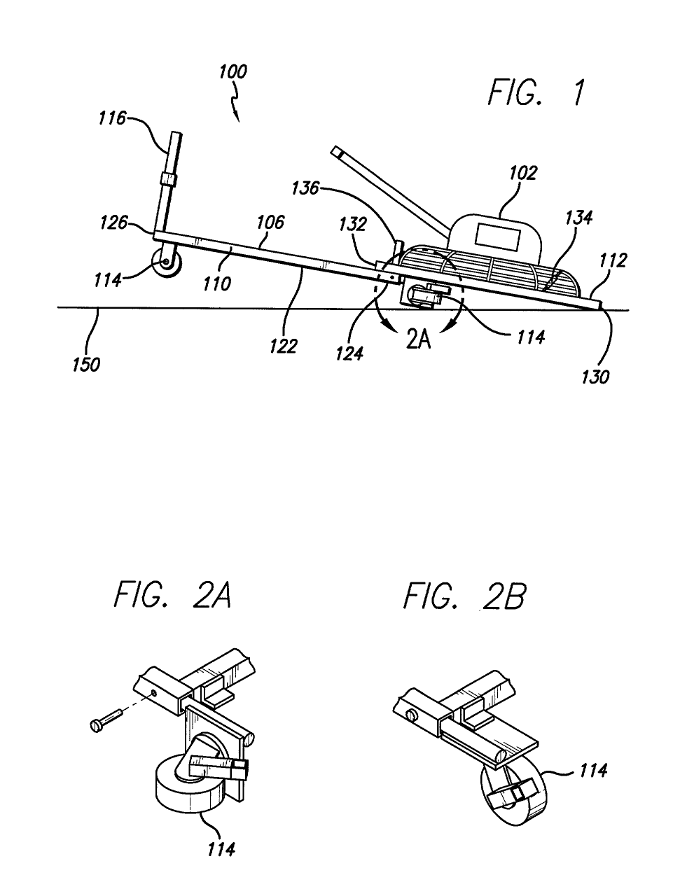

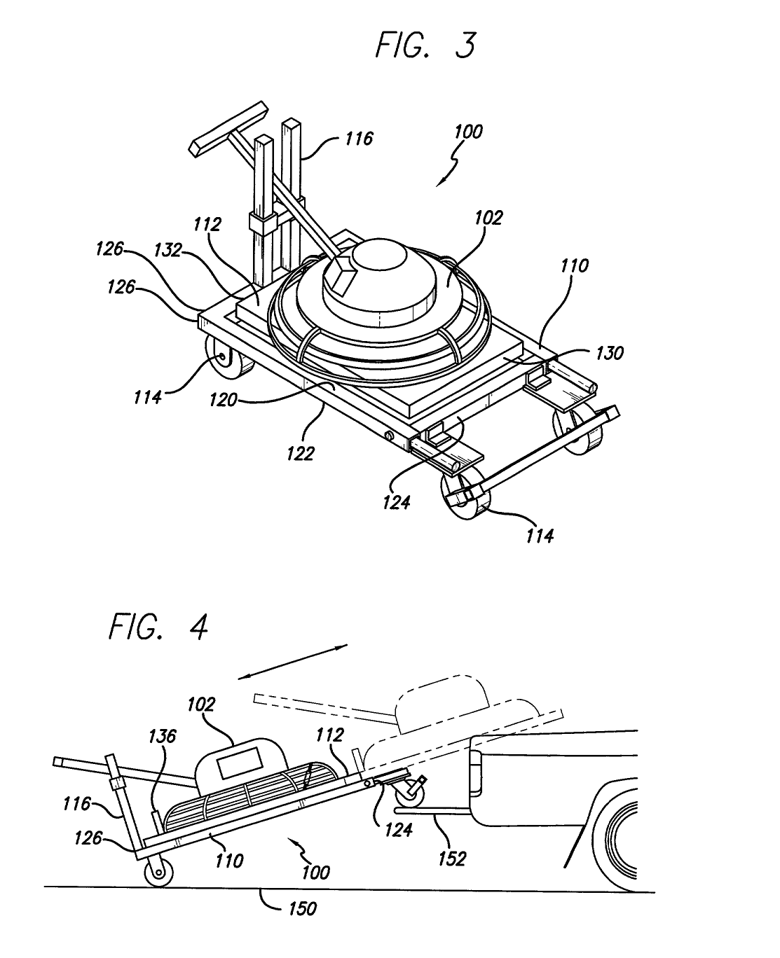

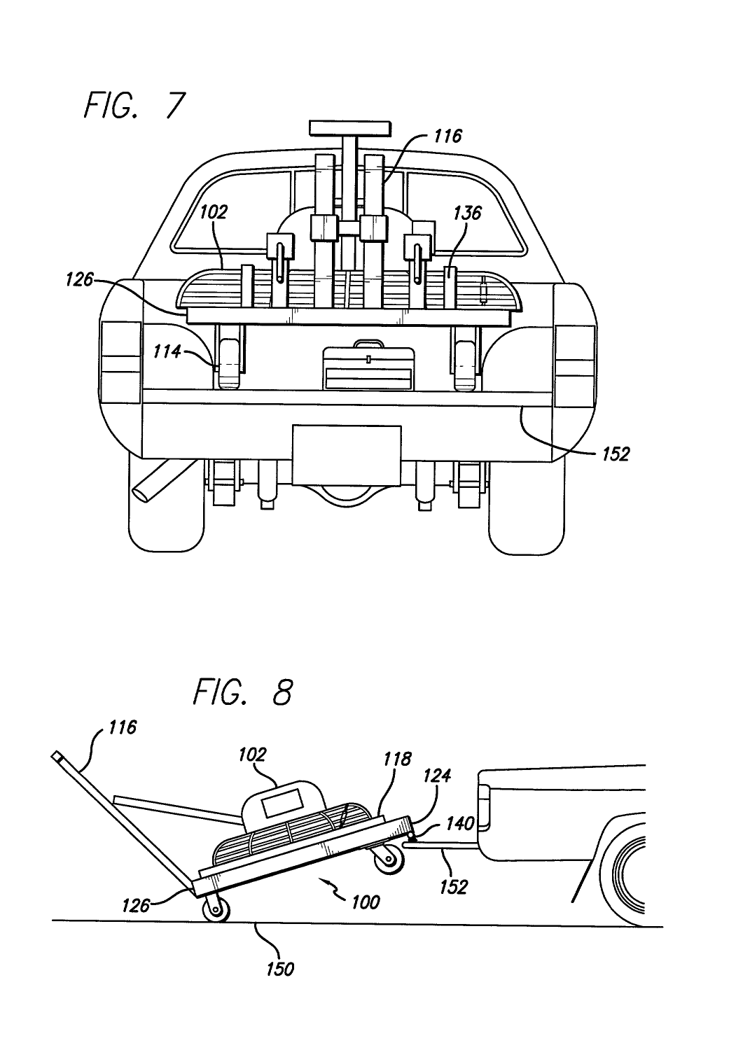

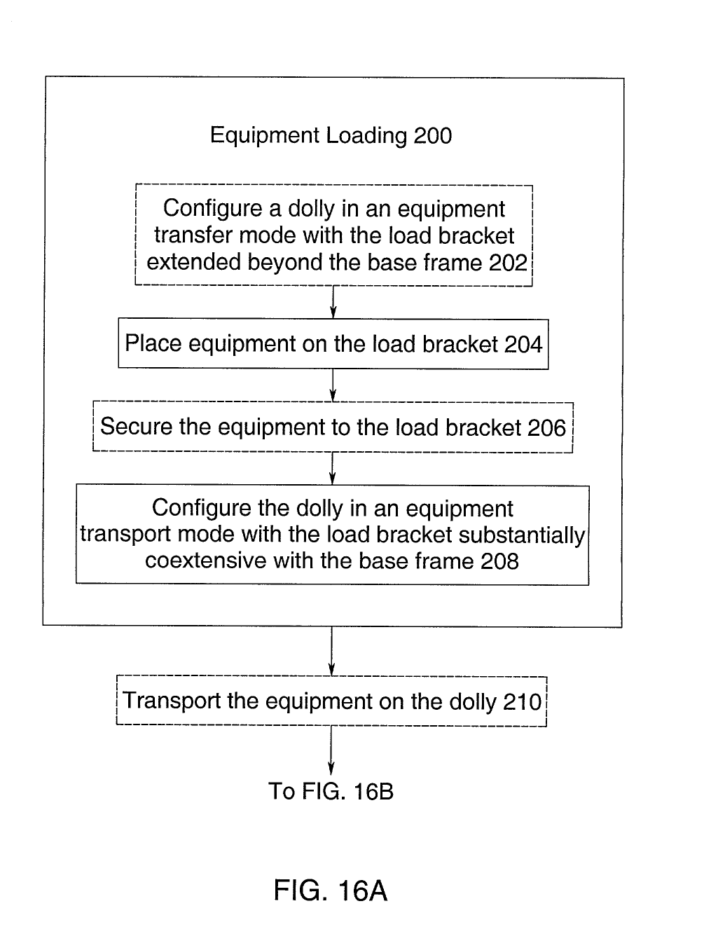

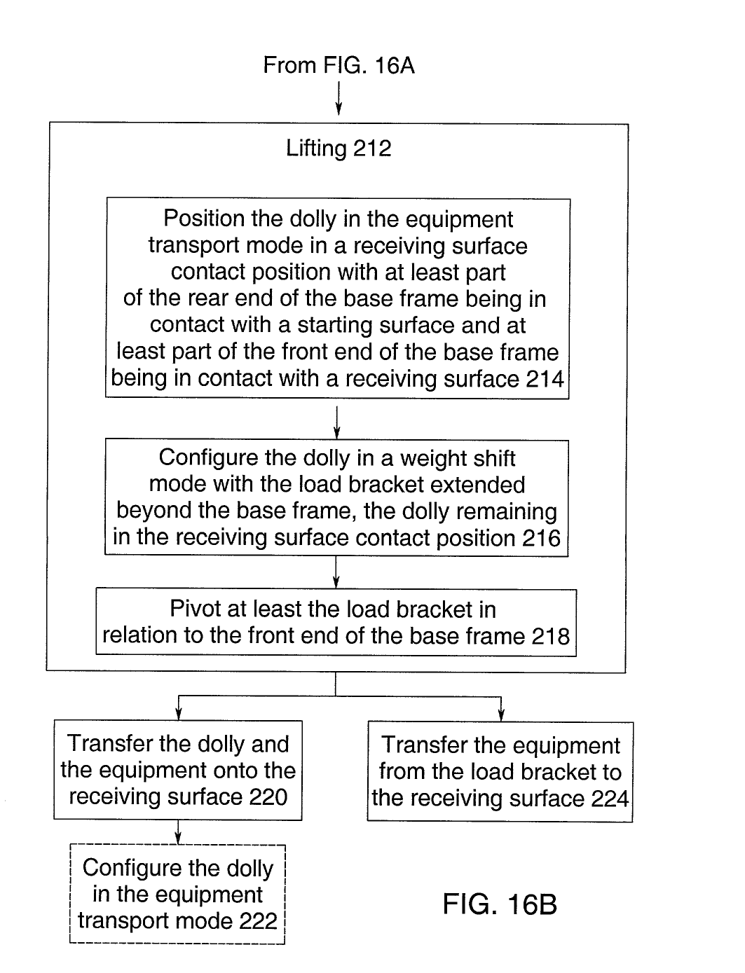

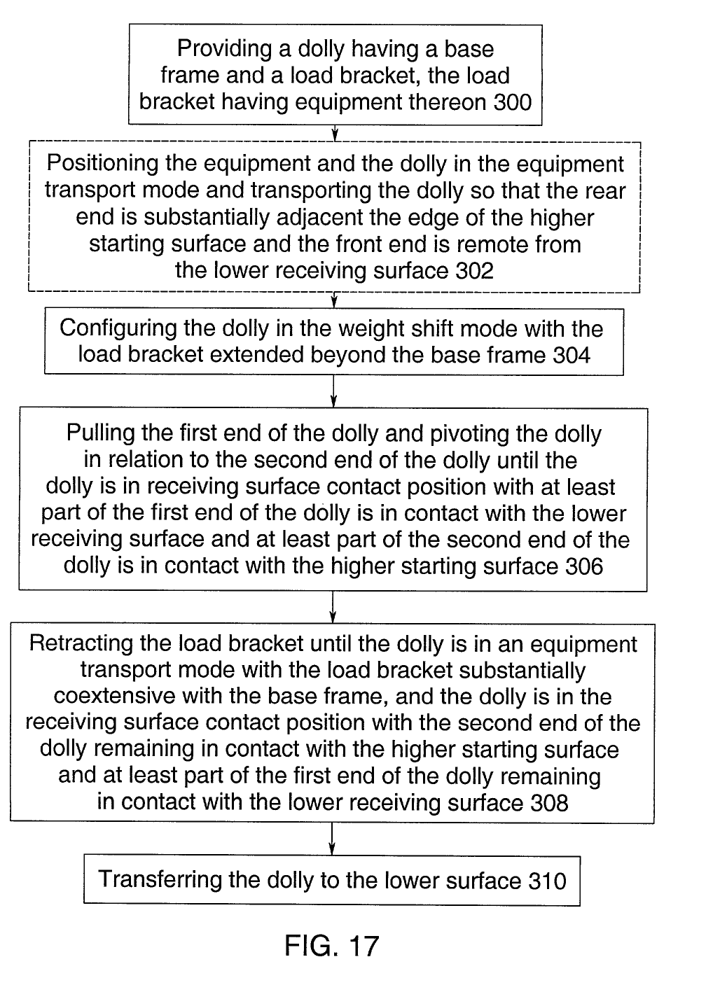

The present invention is directed to a dolly, cart, or other device (hereinafter referred to as “dolly 100”) suitable for loading equipment 102 (FIGS. 1-3) or supporting and transporting equipment 102 (FIG. 3). The dolly 100 of the present invention is also suitable for lifting or lowering equipment 102 from a starting surface onto a receiving surface (FIGS. 4-11). The equipment 102 may be transferred onto the receiving surface either together with the dolly 100 (FIGS. 6 and 7) or by itself (FIGS. 10 and 11). Power systems such as those shown in FIGS. 12-14 may be included to assist in the equipment-transfer process. In one preferred embodiment, the dolly 100 includes mechanisms to support the equipment 102 in an equipment-maintenance position (FIG. 15). The present invention also includes methods such as those set forth in FIGS. 16A, 16B, and 17 for lifting or lowering equipment from a starting surface onto a receiving surface.

Structure:

The dolly 100 of the present invention preferably includes a base frame 110. A load bracket 112 is movably connected with the base frame 110. The load bracket 112 substantially supports the equipment 102, particularly as it is lifted or lowered onto a receiving surface. At least one mobility-enabling device 114 is attached to the base frame 110 to allow the dolly 100 to be easily transported from one location to another. An operational member 116 may also be attached to the base frame 110. The operational member 116 allows the dolly 100 to be controlled and maneuvered.

As shown, the base frame 110 of the present invention has a top side 120, a bottom side 122, a front end 124, and a rear end 126. The base frame 110 may be a frame (as shown) or a solid piece. Additional bracing may be included for structural support. A load bracket immobilizer (not shown) may also be incorporated into the base frame 110 to secure the load bracket 112 in one or more specific positions in relation to the base frame 110. The load bracket immobilizer may consist of one or more straps, clamps, hooks, springs, locks, or other mechanisms suitable for holding the load bracket 112 in one or more specific positions in relation to the base frame 110. The load bracket immobilizer may be used, for example, for providing extra securing means for when the base frame 110 is tilted upward on a receiving surface with load bracket 112 is extended beyond the base frame 110.

A load bracket 112 is movably connected with the base frame 110. The load bracket 112 has a leading end 130 disposed toward the front end 124 of the base frame 110 and a following end 132 opposite the leading end 130. The load bracket 112 may be a solid piece (as shown) or a frame. If the load bracket 112 is a frame, additional bracing may be included for structural support. One or more equipment positioner 136 (FIGS. 1 and 4-7) may be included in the load bracket 112 to help correctly position the equipment 102 on the load bracket 112.

In the shown embodiments, the load bracket 112 is slidably connected with the base frame 110 so that the load bracket 112 may be slid along a track, rollers, tube, or other sliding means between an extended position beyond the base frame 110 and a retracted position substantially coextensive with the base frame 110. The sliding may be smooth or incremental and may be powered by a power system (discussed below). Stoppers or other movement limiting mechanisms may be used to prevent the load bracket 112 from extending too far.

An equipment immobilizer 134 may be incorporated into the load bracket 112 to secure the equipment 102 to the dolly 100. The equipment immobilizer 134 may consist of one or more straps, clamps, hooks, or other mechanisms suitable for securing the equipment 102 to the load bracket 112. The load bracket immobilizer discussed above may also be incorporated into the load bracket 112 (in addition to or instead of being incorporated in the base frame 110) to secure the load bracket 112 in a specific position in relation to the base frame 110.

The shown dolly 100 has a plurality of wheels as its mobility-enabling devices 114 attached to the bottom side 122 of the base frame 110. In one preferred embodiment, such as that shown in FIG. 7, the wheels may be pneumatic tires that allow the dolly to be used over varied terrain. In this embodiment the pneumatic tires are large enough to raise the bottom side 122 of the dolly 100 above the wheel wells inside the truck bed. This also enables the user to store additional items under the dolly 100. Other mobility-enabling devices 114 may include other types of wheels or tires, locking casters, rollers, belts, treads, tracks, skids, skis, or other appropriate mobility-enabling devices 114. It should also be noted that any number of mobility-enabling devices 114 may be used (including only a single mobility-enabling device 114). The size of the mobility-enabling device 114 may also be varied depending on the intended purpose of the dolly. The mobility-enabling devices 114 are preferably attached so that they are can be steered and locked, but these features are optional. The placement of the mobility-enabling devices 114 may also be varied according to the intended function of the dolly 100.

FIGS. 1-6 show one preferred embodiment of mobility-enabling devices 114 that can swivel 360 degrees, lock in place to prevent the dolly from moving (as shown in FIG. 4), extend horizontally (to give the dolly 100 a wider wheelbase), and flatten (as shown in FIG. 1). FIGS. 2A and 2B detail the connection of these mobility-enabling devices 114. This connection, however, is meant to be exemplary and is not meant to limit the scope of the invention.

The shown dolly also has an optional operational member 116 (shown as a control handle) attached to the base frame 110. FIGS. 3 and 7 show a first preferred embodiment of the operational member 116, shaped like an H, so that the handle of the equipment 102 may be placed between the upright members and secured to the cross-member for storage or maintenance. FIGS. 8-10 show a second preferred embodiment of the operational member 116 shaped like a T. FIGS. 11 and 15 show a third preferred embodiment of the operational member 116, shaped like a T, with an additional (possibly removable) cross-member. Using the additional cross-member or maintenance securer 117 of this embodiment, the equipment 102 may be tilted and then secured in the tilted or maintenance position. The first H-shaped embodiment could be used in a similar fashion.

The optional operational member 116 may be foldable, removable, or retractable. Further, the operational member 116 may not be included at all. This is particularly possible if the equipment 102 has its own control handle that can be used to steer the dolly 100 when the equipment 102 is secured to the base frame 110 or load bracket 112. Finally, it is possible that more than one operational member 116 may be included. For example, if the load bracket 112 could be extended beyond either the front end 124 or the rear end 126 of the base frame 110, then a user would not have to turn the dolly 100 around if there was an operational member 116 at both the front end 124 and the rear end 126.

As shown in FIGS. 8-11, in alternative embodiments, one or more feet 140 may be connected to the bottom side 122 of the dolly 100 near the front end 124 of the base frame 110. The feet 140 may be wheels, casters, pads, or any other means of making a stable temporary contact with a receiving surface.

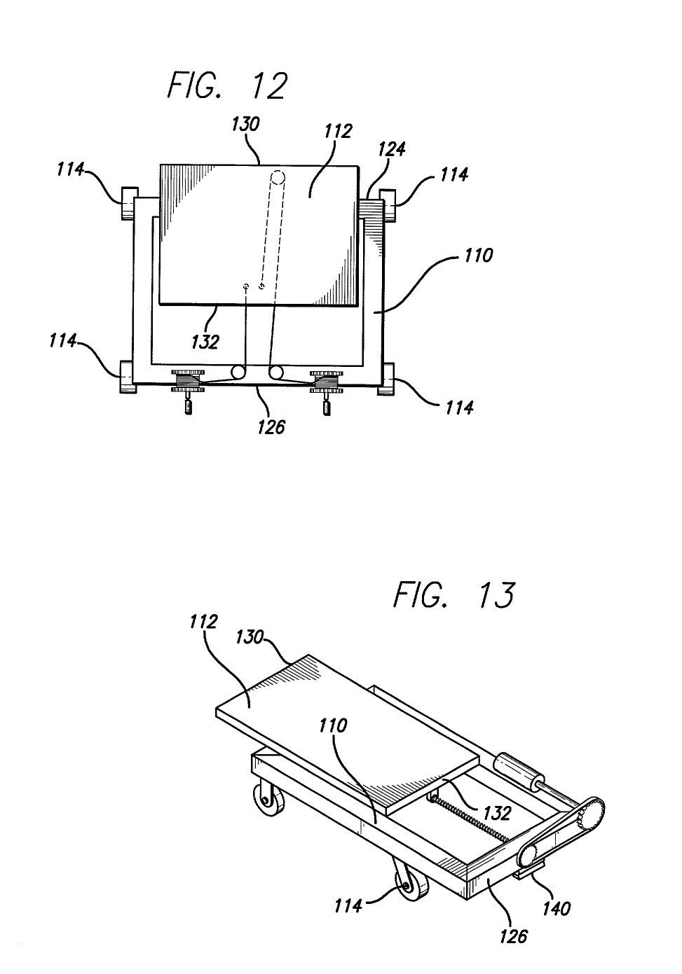

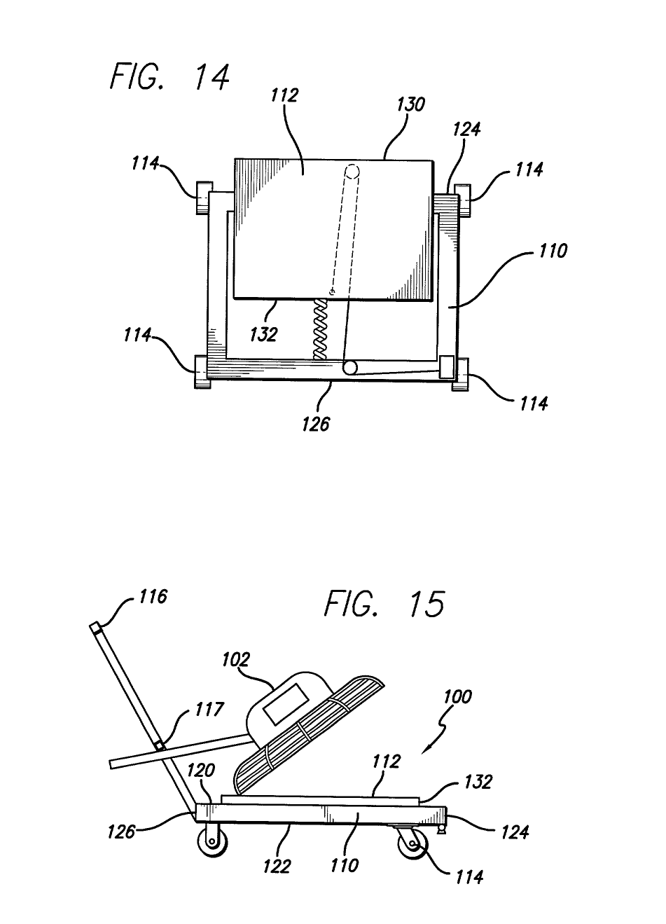

FIGS. 12-14 show exemplary optional power systems for extending and retracting the load bracket 112 in relation to the base frame 110. The power system could be used at any time the load bracket 112 was extended or retracted. FIG. 12 shows an exemplary two-winch, two-cable system in which one winch is the extender winch and one winch is the retractor winch. FIG. 13 shows an exemplary preferred embodiment of the power system that uses a geared train, a worm screw, and an electric motor for extending and retracting the load bracket 112. FIG. 14 shows another exemplary embodiment of a power system that uses a single winch, pulleys, cable, and an optional spring. Other power systems may include various combinations of motors, manual systems, winches, hand cranks, pistons, levers, or other power means. These power systems may move the load bracket 112 using any combination of gears, chains, rods, belts, pulleys, cables, and other mechanical linkages.

Other optional features may include built-in brackets and containers for holding tools. For example, when an embodiment of the dolly is used for concrete power trowels, appropriately shaped brackets may hold finishing tools such as bowl floats, pole handles for the bowl floats, knee-sliders, small hand tools, and buckets.

Method:

FIGS. 16A and 16B shows one preferred method of using the present invention to load equipment 102 onto the dolly 100, transport the equipment 102 on the dolly 100, and lift the dolly 100 and the equipment 102 (or the equipment 102 alone) from a lower surface 150 (also referred to as a lower starting surface when the equipment 102 is to be lifted) to a higher surface 152 (also referred to as a higher receiving surface when the equipment 102 is to be lifted). This method assumes that the dolly 100 has a base frame 110 and a load bracket 112, but any of the embodiments described above could use this method or a variation of this method. Some of the variations of the method are specifically set forth, and some would be obvious, based on the particular embodiments of the dolly 100 and the intended use of the dolly 100.

One preferred method of loading 200 equipment 102 on a dolly 100 uses the dolly 100 of FIG. 1 that has the mobility-enabling devices 114 of FIGS. 2A and 2B. In this method, the dolly 100 is configured in an equipment-transfer mode with horizontal, lowered, or flattened mobility-enabling devices 114 and the load bracket 112 extended 202 beyond the base frame 110. The equipment-transfer mode allows equipment 102 to be easily pulled or pushed onto the load bracket 112. It should be noted, that if the mobility-enabling devices 114 cannot be lowered (such as those in the embodiment of FIG. 3), alternative embodiments could include an integral ramp (not shown) in which a ramp is attached to the base frame 110 or load bracket 112 so that the ramp can be slid, rotated, hinged, or otherwise extended beyond the front end 124 of the base frame 110 to assist the user in loading the equipment 102 onto the dolly 100. Other means to assist the user in loading the equipment 102 may also be included, or this feature could be optional.

Regardless of whether there are specific structural means incorporated in the dolly 100 to assist the user in loading the equipment 102, the dolly 100 may be configured in an equipment-transfer mode with the load bracket 112 extended beyond the base frame 110. If the mobility-enabling devices 114 are lowered sufficiently, the extended load bracket 112 will substantially touch the ground so as to form a ramp. If the mobility-enabling devices 114 are not lowered at all or only lowered a few degrees, the dolly 100 can be tilted forward (as shown in FIG. 1) so that the load bracket 112 will form a ramp. The dolly 100 will not need to be configured in an equipment-transfer mode if the equipment 102 is already loaded or if the equipment 102 is to be lifted onto the load bracket 112.

If it has not already been done, the equipment 102 is then placed on the load bracket 204. In some of the preferred embodiments, one or more optional positioners 136 are used to help position the equipment 102. In some of the preferred embodiments, the equipment 102 is then secured 206 to the load bracket 112 using the equipment immobilizer 134 of FIG. 1 or other securing devices. The step of securing the equipment 102 to the load bracket 112 is optional.

Once the equipment 102 is on the dolly 100, the dolly 100 is then configured in an equipment transport mode 208 (FIG. 3) with the load bracket 112 substantially coextensive with the base frame 110. In this configuration, the dolly 100 is preferably transportable 210 over a variety of surfaces and may be used to transport the equipment 102 about a job site or just positioned to where it is to be lifted or lowered onto a receiving surface.

The dolly 100 with the equipment 102 thereon, may then be used for lifting 212 the equipment 102 alone (FIGS. 8-11) or together with the dolly 100 (FIGS. 4-7) from the lower starting surface 150 to the higher receiving surface 152.

As shown in FIGS. 4 and 8, the dolly 100 in the equipment transport mode (with the load bracket 112 substantially coextensive with the base frame 110) is then positioned in a receiving surface contact position 214. This may be done, for example, by pushing back on the operational member 116 to raise the front end 124 just above the higher receiving surface 152, transporting the tilted dolly 100 to the higher receiving surface 152, and then lowering the raised front end 124 until it rests on the higher receiving surface 152. In the receiving surface contact position, at least part of the rear end 126 is put into contact with a lower starting surface 150 and at least part of the front end 124 is put into contact with a higher receiving surface 152. In the embodiment of FIG. 4, at least one mobility-enabling device 114 is used as the point of contact with the higher receiving surface 152. In one preferred embodiment in which the mobility enabling devices 114 are wheels or casters, the mobility-enabling devices 114 are locked or secured to prevent them from rolling. In the embodiment of FIG. 8, at least one foot 140 is used as the point of contact with the higher receiving surface 152.

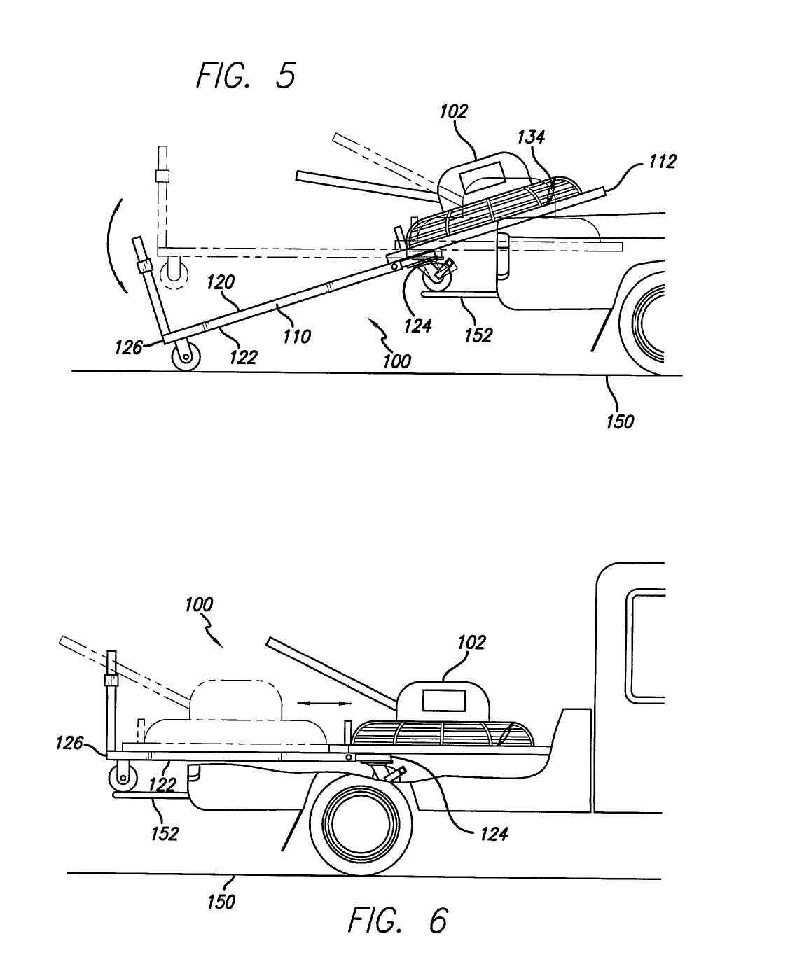

As shown in FIG. 4 (in phantom) and FIG. 5, the dolly 100 is then configured in a weight-shift mode 216, with the load bracket 112 extended beyond the base frame 110. Throughout this step, the dolly 100 remains substantially in the receiving surface contact position with at least part of the rear end 126 remaining in contact with the lower starting surface 150 and at least part of the second front end 124 remaining in contact with the higher receiving surface 152. As discussed above, the load bracket 112 may be extended using a power system. The weight-shift mode is designed to shift the center of gravity to allow easy pivoting.

Once the dolly 100 is configured in the weight-shift mode, the load bracket 112 may then be pivoted 218 in relation to the front end 124. (This could also be described as being pivoted about the front end 124 or being pivoted in relation to the higher receiving surface 152.) As shown in FIGS. 5 and 10, the load bracket 112 may be pivoted in conjunction with the base frame 110. The mobility-enabling devices 114 or the feet 140 act as a pivot-point so that the equipment 102 is lowered while simultaneously raising the rear end 126 off the ground. In the embodiment of FIG. 11, the load bracket 112 is pivoted alone. This embodiment may include a release mechanism, such as a latch (not shown), that releases the load bracket 112 from sliding movement parallel to the base frame 110 so that the load bracket 112 may pivot in relation to the base frame 110. After release, the leading end 130 of the load bracket 112 is allowed to descend to the higher receiving surface 152. The pivoting may be accomplished by means of a hinge 134 or other means of movably attaching the load bracket 112 to the base frame 110. (A separate load bracket power system may be used to assist in this pivoting.)

As shown in FIG. 6, in one preferred embodiment, the dolly 100 and the equipment 102 are transported 220 (generally by pushing or pulling the dolly 100) together onto the higher receiving surface 152. This step may be done after or simultaneously with the pivoting step 218. This embodiment is particularly useful if the dolly 100 will be necessary for unloading at another site. As shown in FIGS. 6 and 7, once the dolly 100 is on the higher receiving surface 152, the dolly 100 may be optionally configured in the equipment transport mode 222 (with the load bracket 112 substantially coextensive with the base frame 110) so that the dolly 100 takes up less room and is easy to transport and/or store.

In the alternate preferred embodiment shown in FIG. 10, the equipment 102 alone may be transferred 224 from the load bracket 112 to the higher receiving surface 152. In this embodiment, after the load bracket 112 and the base frame 110 have been pivoted 218, the rear end 126 may be supported either by a support brace 156 (FIG. 10), other support structure, or by the user or an assistant. The equipment 102 can then be transferred from the load bracket 112 onto the higher receiving surface 152.

In the alternate preferred embodiment shown in FIG. 11, the equipment 102 may be transferred 224 alone from the load bracket 112 to the higher receiving surface 152. In this embodiment, after the load bracket 112 alone has been pivoted 218, the equipment 102 can then be transferred from the load bracket 112 onto the higher receiving surface 152.

FIG. 17 shows one preferred method of using the present invention to lower the dolly 100 and the equipment 102 from a higher surface 152 (also referred to as a higher starting surface when the equipment 102 is to be lowered) to a lower surface 150 (also referred to as a lower receiving surface when the equipment 102 is to be lowered). Although this method is described assuming that the equipment 102 is already on the dolly 100, 300 (as would be the case after equipment 102 has been loaded onto the bed of a truck), the loading 200 of the equipment 102 into the dolly 100 and transporting 212 steps discussed above could be applied here.

If it has not already been done, the equipment 102 and the dolly 100 can be configured 302 in the equipment transport mode and transported 302 so that the second rear end 126 of the base frame 110 is substantially adjacent to the edge of the higher starting surface 152 and the front end 124 remote from the lower receiving surface 150. This would substantially as shown in phantom FIG. 6.

The dolly 100 is preferably configured 304 in the weight-shift mode with the load bracket 112 extended beyond the base frame 110. This would be substantially as shown in FIG. 6. A power system may be used to extend the base frame 110.

A user may, for example, pull 306 the rear end 126 of the base frame 110 and pivot 306 the dolly 100 (FIG. 5 in phantom) in relation to the front end 124 of the base frame 110 (FIG. 5 and FIG. 4 in phantom) until the dolly 100 is in receiving surface contact position with at least part of the rear end 126 of the base frame 110 is in contact with the lower receiving surface 150 and at least part of the front end of the base frame 110 is in contact with the higher starting surface. 152. Alternatively, the user may use other means to position the dolly 100 in the receiving surface contact position.

Once the dolly 100 is in the receiving surface contact position, the load bracket 112 may then be retracted 308 (FIG. 4) until the dolly 100 is in an equipment transport mode with the load bracket 112 substantially coextensive with the base frame 110. Throughout this step, the dolly 100 preferably remains in the receiving surface contact position with the front end 124 remaining in contact with the higher starting surface 152 and at least part of the rear end 126 remaining in contact with the lower receiving surface 150.

The dolly is then transferred 310 to the lower receiving surface 150. This may be done, for example, by pushing back on the operational member 116 to raise the front end 124 of the base frame 110 just above the higher receiving surface 152, transporting the tilted dolly 100 to the higher receiving surface 152, and then lowering the raised front end 124 until it rests on the higher receiving surface 152.

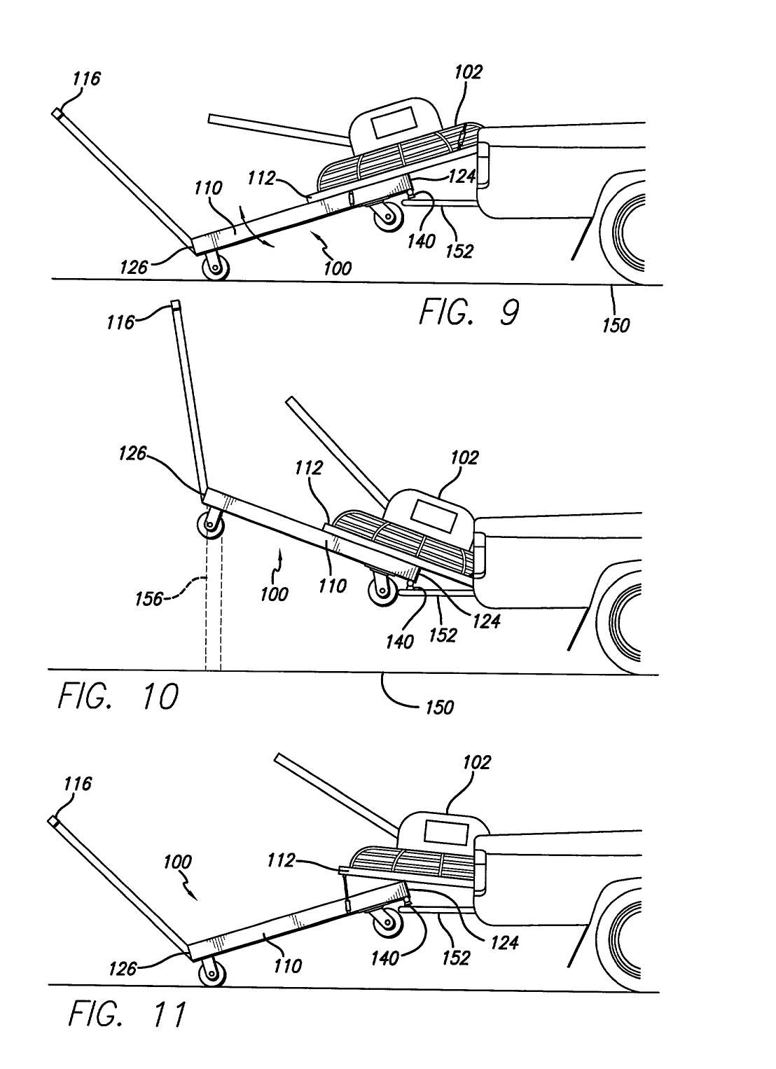

The method of FIG. 17 could be modified to be adapted to the embodiments shown in FIGS. 8-11. Summarily, the empty dolly 100 could be positioned as shown in either FIG. 10 or FIG. 11 (but without the equipment 102 thereon). Then, the equipment 102 could be loaded onto the load bracket 112. Either the load bracket 112 alone (FIG. 11) or combined with the base frame 110 (FIG. 10) would then be pivoted until at least part of the rear end 126 is in contact with the lower receiving surface 150 and at least part of the front end 124 is in contact with the higher starting surface 152. As shown in FIG. 9, this would result in the dolly 100 being configured in a weight-shift mode in the receiving surface contact position. The load bracket 112 could then be retracted until the dolly is in an equipment transport mode in the receiving surface contact position (FIG. 8). The dolly 100 may then be transferred to the lower receiving surface 150.

Miscellaneous:

Equipment may include tools (e.g., rototillers, concrete power trowels, floor polishers, walk-behind power (or manual) tools, washers, dryers, refrigerators), vehicles (e.g., snowmobiles, motorcycles), supplies (e.g. boxed goods, loose supplies), or any equipment for which transport, lifting, and/or loading is desired. Although this invention was primarily designed for transporting equipment having unstable wheels or no wheels, the pneumatic wheels of one of the preferred embodiments allow easy transport over rough terrain, and therefore, the invention may be desirable for use even with equipment that has wheels suitable for normal transport but not suitable for rough terrain. Further, the lifting and loading capabilities of the present invention may be used with any type of equipment, although the size and strength of the dolly 100 may have to be adapted for the size and weight of the equipment 102.

Alternate embodiments of the present invention are within the scope of the invention. For example, the various embodiments of the base frame 110, load bracket 112, mobility-enabling devices 114, and operational member 116 may be interchanged depending on the desired function of the dolly 100. Further, optional features such as the operational member 116, maintenance securer 117, equipment immobilizer 134, equipment positioner 136, may be modified, omitted, or alternately positioned depending on their desired functions.

It should also be noted that terminology in this description is meant to assist in the understanding of the invention and is not meant to limit the scope of the invention. For example, the terms front end 124 and rear end 126 are meant to be relational. For example, if the load bracket 112 can be extended beyond the base frame 110 in either direction, then these terms could be synonymous. Further, the term rear end 126 may include any mobility-enabling devices 114 attached thereto and the term front end 124 may include any mobility-enabling devices 114 or feet 140 attached thereto. This is significant because the descriptions of the front and rear ends 124, 126 contacting the starting and receiving surfaces may in fact have mobility-enabling devices 114 or feet 140 as the actual point of contact.

The terms and expressions that have been employed in the foregoing specification are used as terms of description, not of limitation, and are not intended to exclude equivalents of the features shown and described or portions of them. The scope of the invention is defined and limited only by the claims that follow.

What is claimed is:

1. A dolly for transporting, loading, and lifting equipment from a starting surface onto a receiving surface, said dolly comprising:
(a) a base frame having a front end and a rear end opposite said front end;
(b) at least one mobility-enabling device attached to said base frame;
(c) a load bracket slidably connected to said base frame;
(d) a power system for slideably extending and retracting said load bracket in relation to said base frame; and
(e) at least said load bracket being pivotable in relation to at least part of said front end.

2. The dolly of claim 1, wherein said at least one mobility-enabling device is at least one wheel.

3. The dolly of claim 1, wherein at least one mobility-enabling device at said front end is flattenable, said front end being lowered when said at least one mobility-enabling device at said front end is flattened.

4. The dolly of claim 1, said base frame further comprising at least one foot connected to said base frame for contacting said receiving surface.

5. The dolly of claim 4, wherein said dolly is pivotable on said at least one foot.

6. The dolly of claim 1, wherein said load bracket being pivotable in relation to said base frame.

7. The dolly of claim 1, wherein said base frame further comprises an operational member.

8. The dolly of claim 1, wherein said power system is comprised from elements selected from the group consisting of:
(a) at least one electric motor;
(b) at least one pneumatic system;
(c) at least one hand crank;
(d) at least one winch;
(e) at least one lever;
(f) at least one piston;
(g) at least one spring;
(h) at least one pulley;
(i) at least one worm screw;
() at least one cable; and
(k) at least one mechanical linkage.

9. A method for lifting equipment from a starting surface onto a receiving surface, said method comprising the steps of:
(a) providing a dolly having a base frame and a slideable load bracket, said base frame having a front end and a rear end, said load bracket for supporting said equipment thereon;
(b) configuring said dolly in an equipment transport mode with said load bracket substantially coextensive with said base frame;
(c) positioning said dolly in said equipment transport mode in a receiving surface contact position wherein at least part of the rear end is in contact with the starting surface, and at least part of the front end is in contact with the receiving surface;
(d) configuring said dolly in a weight-shift mode with said load bracket extended beyond said base frame, said dolly remaining in said receiving surface contact position;
(e) pivoting at least said load bracket in relation to said front end; and
(f) transferring at least said equipment onto said receiving surface.

10. The method of claim 9, wherein said step of providing a dolly further comprising the step of providing a dolly having at least one mobility-enabling device attached thereto.

11. The method of claim 10, further comprising the step of transporting said dolly using said at least one mobility-enabling device.

12. The method of claim 10, said step of providing a dolly having at least one mobility-enabling device further comprising the step of providing a dolly having at least one flattenable mobility-enabling device attached to said front end.

13. The method of claim 12, further comprising the step of flattening said mobility-enabling device to lower said front end for loading equipment onto said load bracket.

14. The method of claim 9, wherein said step of positioning said dolly in said equipment transport mode in a receiving surface contact position further comprises the step of tilting said dolly to raise said front end.

15. The method of claim 9, wherein said step of pivoting at least said load bracket further comprises the step of pivoting said load bracket in relation to said base frame and said front end.

16. The method of claim 15, wherein said step of transferring at least said equipment further comprises the step of transferring only said equipment onto said receiving surface.

17. The method of claim 9, wherein said step of pivoting at least said load bracket further comprises the step of pivoting both said load bracket and said base frame in relation to said front end.

18. The method of claim 17, wherein said step of transferring at least said equipment further comprises the step of transferring only said equipment onto said receiving surface.

19. The method of claim 17, wherein said step of transferring at least said equipment further comprises the step of transferring said equipment and said dolly onto said receiving surface.

20. A method for lowering equipment from a starting surface onto a receiving surface, said method comprising the steps of:
(a) providing a dolly having a base frame and a slideable load bracket, said base frame having a front end and a rear end; said load bracket for supporting equipment thereon;
(b) positioning said dolly so that said rear end is substantially adjacent on edge between starting surface and said receiving surface and so that said front end is remote from said receiving surface;
(c) configuring said dolly in a weight-shift mode with said load bracket extended beyond said base frame;
(d) pulling said rear end and pivoting said dolly in relation to said front end until said dolly is in a receiving surface contact position with at least part of said rear end in contact with said receiving surface, and at least part of said front end in contact with said starting surface; said dolly remaining in said weight-shift mode;
(e) retracting said load bracket until said dolly is in an equipment transport mode with said load bracket substantially coextensive with said base frame, said dolly remaining in said receiving surface contact position; and
(f) transferring said dolly onto said receiving surface.

21. A dolly for lifting and lowering equipment from a starting surface to a receiving surface, said dolly comprising:
(a) base frame having a front end and a rear end;
(b) a load bracket slideably connected to said base frame;
(c) a power system for slideably extending and retracting said load bracket between at least two modes selected from the group consisting of:
(i) an equipment-transfer mode with said load bracket extended beyond said base frame;
(ii) an equipment transport mode with said load bracket substantially coextensive with said base frame; and
(iii) a weight-shift mode with said load bracket extended beyond said base frame; and
(d) at least said load bracket being pivotable in relation to at least part of said front end.

22. The dolly of claim 21, further comprising at least one mobility-enabling device connected to said base frame.

23. The dolly of claim 22, wherein at least one of said mobility-enabling devices is connected to said front end, at least said load bracket being pivotable on said mobility-enabling device connected to said front end.

24. The dolly of claim 21, further comprising at least one foot connected to said front end, at least said load bracket being pivotable on said foot.

25. The dolly of claim 21, further comprising an operational member connected to said base frame.
